(19) United States
(12) Patent Application Publication
(10) Pub. No.: US 2007/0105594 A1
(43) Pub. Date: May 10, 2007

(54) Method for the determination of an antenna weighting factor

(76) Inventors: Frank Burkert, Munchen (DE); Heino Gerlach, Munchen (DE)

Correspondence Address: BELL, BOYD & LLOYD, LLP, P.O. BOX 1135, CHICAGO, IL, 60690, US

(21) Appl. No.: 10/561,731

(22) PCT Filed: Apr. 29, 2004
(86) PCT No.: PCT/EP04/50652

§ 371 Date: Dec. 20, 2005

(30) Foreign Application Priority Data
Jun. 20, 2003 (DE) 10327896.6

(51) Int. Cl. H04M 1/00

(52) U.S. Cl. 455/562.1; 455/101

(57) ABSTRACT

The present disclosure relates to a method for the determination of an antenna weighing factor for base stations of a cellular radio network, wherein a radio link to a terminal can be established simultaneously via several base stations which respectively transmit in a parallel manner via several transmission paths from various antennas to the terminal. The terminal respectively determines channel coefficients for the transmission paths for the associated base stations and determines an antenna weighting factor using the channel coefficients and transmits the coefficients to the base stations. A transmission quality value of a transmission channel between the respective base station and the terminal is determined for the individual base stations and the channel coefficients of the individual base stations are prioritized and taken into account using the determined antenna weighting factor.

### FIELD OF TECHNOLOGY

The present disclosure relates to a method for the determination of an antenna weighting factor for adjusting an antenna weighting in base stations of a cellular radio network, wherein a radio link between a mobile terminal and the network can be established simultaneously via a plurality of base stations which respectively transmit in a parallel manner via a plurality of transmission paths from various antennas to said the terminal. In response, the terminal respectively determines channel coefficients for the transmission paths between the antennas of the respective base station and the terminal. Furthermore, the terminal determines an antenna weighting factor using the channel coefficients, and transmits said factor to the base station. The disclosure also relates to a method for operating a cellular radio network in which the antenna weighting factor is determined according to such the aforementioned method, together with a mobile terminal.

### BACKGROUND

In modern mobile radio systems, such as third generation UMTS networks, base stations are able to transmit simultaneously via a plurality of transmission antennas. Typically, two transmission antennas are used in the current UMTS specifications. The advantage of this method, known as a “transmit diversity method,” is that the transmitted signals are transported in a parallel manner via various transmission paths, thus increasing the probability of the message arriving perfectly at the mobile terminal via at least one path. This makes the transmission channel connection from the base station to the mobile terminal more reliable and reduces the occurrence of such errors as frame error rate and bit error rate. An improvement in transmission channel quality of this kind leads directly to an increase in the cell capacity of the system, that is, it allows a greater number of possible subscribers in a cell.

In order to maximize transmission antenna power at the base station local to the terminal, signals transmitted via the different transmission paths should be coherently superposed at the reception site, making positive interference possible. Such maximizing of the received power is achieved if the base station sets a suitable antenna weight according to a predefined optimum antenna weighting factor. On the one hand this antenna weighting factor predefines a phase offset between the different antennas, with the offset corresponding to the relative phase between the signals transmitted by the different antennas. In certain transmission methods, for example in the mode 2 method within a UMTS network, it is also possible to predefine not only the antenna weighting factor, but also what is known as a power offset, which defines how the transmission power is divided among the different antennas.

Since in the final analysis it is only the terminal itself that can establish the power the terminal receives, the terminal estimates a value known as the “channel impulse response” on the respective channel from the base station to the terminal. For example, in the method known as the “closed loop transmit diversity method,” defined in the 3 GPP UMTS specifications, it does this with the aid of control signals transmitted by the base stations. The channel impulse response of the channel from the base station to the terminal (also known as the downlink channel) consists of complex channel coefficients for the individual transmission paths from the different antennas of the base station to the terminal. The terms “channel impulse response” and “channel coefficients” will therefore be used as synonyms from this point on. The control signal is deemed to be known to the terminal. The channel used for this purpose in the UMTS network is called the common pilot channel (CPICH) and is used by a plurality of mobile terminals. The channel coefficients are then used in the terminal to determine the optimum antenna weighting factor.

The terminal can determine the antenna weighting factor by maximizing the received power P according to the following equation.
P=w^{H}H^{H}Hw (1)

Here the antenna weighting factor w and the channel impulse response H estimated by the terminal are vectors consisting of the individual antenna weighting factors for the different antennas and/or the channel coefficients of the different transmission paths. H is a vector only in the special case where a signal is transmitted by a base station on only one path. In the general case H represents a matrix in which each column stands for transmission via one path. However, this has no effect on the weighting vectors themselves. The following applies to a base station with two transmission antennas, as is the case in the current UMTS standard:

$$\underline{w} = [ \frac{{w}_{a}}{{w}_{b}} ] ; H = ⌊ {h}_{a ,} {h}_{b} ⌋ \qquad ( 2 )$$

In this example wₐ and w_{b} are the individual weighting factors for the two antennas of the base station, and hₐ and h_{b} are the individual channel coefficients for the transmission paths of the two antennas to the terminal. In principle however it is also possible to expand to more than two antennas. In equation (1) w^{H} is the conjugate complex transposed vector of w and H^{H} is the conjugate complex transposed vector or conjugate complex matrix of H.

The terminal then transmits the antenna weighting factor w, which has been determined as described and is optimum in the view of the terminal, to the base stations via the usual transmission channel known as the uplink channel. Under the current UMTS standard this typically takes place via the dedicated physical control channel or uplink DPCCH. The term “uplink” refers to the connection from the terminal to the base station. Furthermore the signal containing the antenna weighting factor is usually known as the feedback message. The antenna weighting factor which the terminal has signaled is then used by the base station to apply an appropriate setting to the downlink channel from the base station to the terminal. A disadvantage in current mobile radio systems is that the feedback message is transmitted on the uplink channel from the terminal to the base station without additional error protection, since every error protection measure, such as the addition of a parity bit or transmission of redundant data, would involve an additional data overhead. A bit error rate in the feedback message, known as the feedback error rate and amounting to a certain percentage, is inevitable. Currently, feedback error rates between 4% and 10% are typical. If an error occurs in the feedback message, the base station then does not use the antenna weighting factor computed by the terminal but a suboptimal antenna weighting factor instead. It is then necessary to take account of the fact that for instance in the case of the feedback message, in operating mode 1 as provided for in the UMTS standard, only two bits are used to transmit one of four possible antenna weights with different phase offsets to the base station. In a further mode 2 there are four bits for specifying to the base station in total one of 16 options for the antenna weight, the first three bits containing the phase offset and the last bit containing the power offset. Thus a single defective bit can cause a situation in which the antenna weighting factor received by the base station differs significantly from the antenna weighting factor determined by the terminal. It is quite seldom that a bit error leads to only a slight deviation of the received antenna weighting factor from the transmitted antenna weighting factor. It is true that on receiving the signals transmitted by the base station, the mobile terminal can as a rule use an antenna weight verification method, explained in detail later, to ascertain whether the base station concerned is using suboptimal antenna weighting factors instead of the predefined antenna weighting factors. However, this still does not prevent the fact that when the base station uses incorrect antenna weighting factors the power received at the terminal is below the optimum.

Even more problematical is the case of those systems in which the terminal simultaneously receives signals from a plurality of different base stations where a radio connection is maintained between the terminal and the network in a parallel manner via a plurality of base stations. In the UMTS standard this is possible for instance in the mode known as frequency division duplex, or FDD mode. This method has the advantage that a terminal which moves within the network can be transferred smoothly between the individual base stations, said method also being known as “soft handover”. Consequently in this soft handover there is no “hard” changeover from one channel to another channel when the mobile radio terminal moves from one cell to another cell. Instead, as soon as the terminal is in range of a base station, an additional connection is established to this base station while the connection via the other base stations is maintained. The connection is broken only when the terminal moves out of range of a base station, whilst the remaining connections continue to be maintained. Since two or more base stations are usually transmitting the same signal, this method also increases the reception quality and decreases the probability of network connection breaks.

Under such a configuration, the terminal separately demodulates and then combines the signals it receives from the different base stations via different downlink channels, which, in the case of UMTS, are the downlink DPCH, or downlink dedicated physical channels. However, the transmit end of the terminal has only one physical uplink channel, that is, the terminal transmits only one signal, which is sent to all base stations. The significance of this for optimizing the antenna weighting factors of the individual base stations in the context of the method explained above is that the terminal cannot purposely transmit to each base station the antenna weighting factor that is optimal for that particular base station in order to optimize the individual downlink channels between the different base stations and the terminal. Instead it must determine a common antenna weighting factor which maximizes the received power of the sum of all downlink channels.

This can be achieved in a manner analogous to equation (1) by maximizing the power P as follows:
P=w^{H}(H_{B1}^{H}H_{B1}+H_{B2}^{H}H_{B2}+ . . . +H_{Bi}^{H}H_{Bi}+ . . . H_{Bn}^{H}H_{Bn})W (3)

In this equation, the vectors or matrixes H_{Bi}, i=1 to n, are in each case the channel impulse response of the i-th base station as estimated by the terminal, and H_{Bi}^{H} represents as before the conjugate complex transposed vectors or matrixes thereof. The antenna weighting factor w determined in this way is then transmitted by the terminal as a feedback message in the usual way on the uplink channel, typically on the uplink DPCCH, or uplink dedicated physical control channel, and is then received and evaluated by all base stations.

However, propagation conditions from the terminal to the base stations generally differ, so that some base stations receive the uplink channel better than others. There is also the fact that under currently applicable standards the transmission power of the terminal is governed in such a way that it is optimized only for base stations with the best propagation conditions. As a result, in certain cases the feedback error rate is in the above-mentioned range of 4% to 10% for only a few of the base stations. The feedback error rate for all the other base stations can be significantly higher, so that it is quite rare for all base stations to use the antenna weighting factor determined by the terminal. On the other hand however, this antenna weighting factor will have been computed so that all base stations use the said antenna weighting factor in order to optimize the received power in common. It is therefore not sufficient for only some base stations to receive the antenna weighting factor correctly and set the antenna weight accordingly. As an overall result it is only in the rarest cases that the power received at the terminal will actually be optimal.

### SUMMARY

Accordingly, a method is disclosed herein to achieve a higher probability of being able to improve the power received at the terminal.

Under an exemplary embodiment, a transmission quality value of a transmission channel between the respective base station and the terminal is determined for the individual base stations, and the channel coefficients of the individual base stations are prioritized and taken into account using the determined antenna weighting factor, in each case as a function of the determined transmission quality value between the base station concerned and the terminal.

This means that when determining the antenna weighting factor, preference is given to base stations which receive the feedback message with sufficiently high reliability. Prioritizing in this way has the advantage that in an error-free uplink channel to all base stations the power received at the terminal is at a maximum, since then all base stations have been taken equally into account in computing the antenna weighting factors. If however the uplink channel can only be very poorly received by some base stations, then due to the defective transfer these base stations use only more or less randomized antenna weighting factors. Thus these base stations can inevitably make a significantly lower contribution to the actual received power than is the assumed case when determining the antenna weighting factors according to the conventional method. Since in the method to which the invention relates these base stations are by contrast not taken into consideration at all or deemed to be only subordinate when determining the antenna weighting factors, the base stations that receive the uplink channel with sufficient quality, and therefore base their settings on the antenna weighting factor determined by the terminal, make a correspondingly higher contribution to the received power. As a result, the entire received power is optimized by the prioritization so that the performance of the method is significantly improved.

One advantage of this configuration is that it is unnecessary to change any standards in the mobile radio network to achieve this, or in other words no special activities are required of the base stations or background network. The terminals are simply able to determine or estimate the quality of the transmission channel, and the nature of the computations within the mobile terminal are changed.

A mobile terminal for such use should have a channel coefficient determination unit for determining the channel coefficients for the transmission paths between the antennas of the base station and the terminal in the case of each of the associated base stations, together with an antenna weighting factor determination unit which uses the channel coefficients to determine an antenna weighting factor and transmits said factor to the base station. Also, a transmission channel control unit should be used for determining, respective of each of the individual base stations, the transmission quality value of a transmission channel between the base station concerned and the terminal. Additionally the antenna weighting factor determination unit should be designed in such a way that when determining the antenna weighting factor, it considers in each case the order of priority of the channel coefficients of individual base stations as a function of the transmission quality value determined between the base station concerned and the terminal. The transmission channel control unit can also be part of the antenna weighting factor determination unit.

The method used to consider the priority of the individual base stations when computing the antenna weighting factor is preferably designed in such a way that the terminal has a prioritization unit that uses the transmission quality values for the individual base stations to determine weighting factors which the antenna weighting factor determination unit uses in computing the antenna weighting factor. The prioritization unit can also be part of the antenna weighting factor determination unit.

Prioritization is preferably carried out in such a way that, when determining the antenna weighting factor, consideration is given only to the channel coefficients of the base station in which the transmission quality value is above or below a certain limit value. The channel coefficients for any other base stations are not considered at all. For this purpose the prioritization unit mentioned above could use for instance the transmission quality values for the individual base stations to determine whether they contain a weighting factor of 0 or 1. Accordingly, when computing the antenna weighting factor according to equation (3) the individual channel coefficients or channel impulse responses H_{Bi} for the different base stations would be multiplied by a weighting factor of either 0 or 1, so that the channel coefficients of the base stations concerned would be considered either in full or not at all.

Alternatively, it is also possible when determining the antenna weighting factor to apply a weighting to the channel coefficients of the base stations which is in direct or inverse proportion to the transmission quality value of the transmission channel between the base station concerned and the terminal. As an example, weighting factors directly proportional to the transmission quality value or inversely proportional to the transmission quality value, could be chosen and multiplied by the channel coefficients or channel impulse response.

It is also possible to use a transmission quality value corresponding to the transmission quality of a downlink channel from the base station to the terminal, such as a value corresponding to the power of the said downlink channel to the terminal. It is then assumed that an approximation of the base stations from which the downlink channel can only be received on low power by the terminal will very probably not be able to receive the feedback message correctly in the uplink channel. Since however, the downlink channels and the uplink channel are in different frequency ranges, this method is only suitable in certain conditions, and it would be preferable to determine a transmission quality value which is a direct measure of the transmission quality in the uplink channel.

There are several options for this. For one thing, the terminal can use the feedback error rate to determine the transmission quality value of the uplink channel. This rate can be determined by checking the antenna weighting factor set by the base station concerned. This feedback error rate is a direct measure of the extent to which the antenna weighting factor received by each base station deviates from the antenna weighting factor originally transmitted, and can therefore also be used directly as a transmission quality value.

The feedback error rate can be determined by means of the antenna weight verification method previously mentioned. Such a method is also already used in the known methods of terminals to find out the antenna weighting factors actually used by the base station and thus to be able to demodulate the downlink dedicated physical channel (DPCH). To determine the antenna weighting factors it is usual for the downlink DPCH to contain a known symbol sequence (known in UMTS as pilot symbols) as a control signal. By comparing the received symbol sequence with the known and expected symbol sequence, the terminal can check whether the signaled optimum antenna weighting factors or other antenna weighting factors have been used by the base station concerned.

Another possible alternative is that the terminal determines a transmission quality value for the uplink channel by means of transmission power request signals that the base station concerned transmits to the terminal. Thus for instance in the UMTS standard of the base stations a transmit power control signal or TPC signal is transmitted at regular intervals in the downlink DPCH, requesting the terminal to increase or reduce the power. If a base station continually requests a higher transmission power, it is assumed that said base station is not receiving the uplink channel satisfactorily enough.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 is a diagram showing part of a mobile radio network having three base stations transmitting simultaneously to a mobile terminal;

FIG. 2 is a diagram of a mobile terminal under an exemplary embodiment;

FIG. 3 is a diagram illustrating the structure of a time slot within a frame of a downlink DPCH according to a UMTS specification.

### DETAILED DESCRIPTION

For the following description it is assumed that the cellular radio network is a UMTS mobile radio network according to the current standard. It is further assumed that—as is usual in the current standard—each base station uses only two antennas to transmit to the terminal. However the invention is expressly not confined to cellular networks of this type. In particular it is also possible for the invention to be used without further modification in networks where the base stations use more than two antennas.

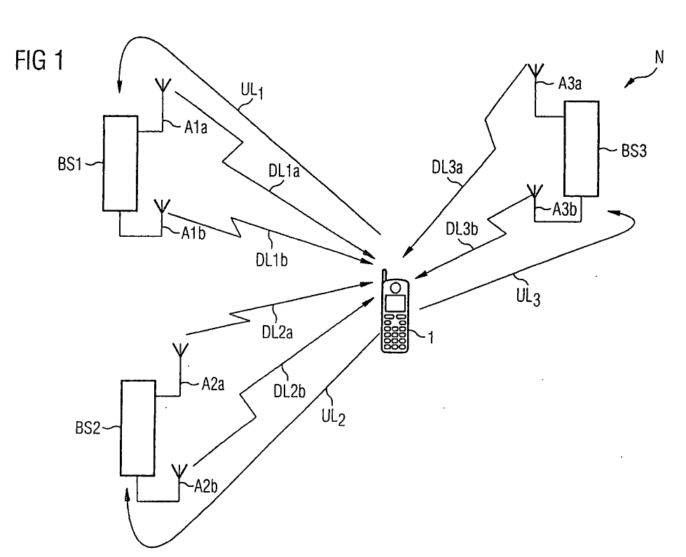

As FIG. 1 shows, it is possible in the UMTS standard for a terminal 1 to maintain a connection to the network N simultaneously via a plurality of base stations BS1, BS2, BS3 (also known as “node B”).

Each of these base stations BS1, BS2, BS3 transmit via a dedicated downlink channel (downlink DPCH), though the transmitted useful data, that is, the data not used for controlling the transmission, is identical in each downlink DPCH. A more detailed explanation may be found in FIG. 3, which shows a slot within a frame of a downlink DPCH. The regions designated DPDCH (dedicated physical data channel) contain in each case only the useful data, for example transmissions of data relating to speech, graphics, text, multimedia etc. This data is transmitted in a parallel manner in each downlink DPCH of the different base stations. The regions designated DPCCH (dedicated physical control channel) contain in each case control signals which are used to enable, maintain and optimize the connection between the respective base station BS1, BS2, BS3 and the terminal 1. This data differs partially in each downlink DPCH of the different base stations BS1, BS2, BS3.

Transmitting the DPDCH via a plurality of base stations produces a higher probability that the terminal 1 receives the useful data correctly and without interference. Furthermore the probability of a complete break in the connection between the terminal 1 and the network N is reduced. This method also makes the previously described soft handover method possible.

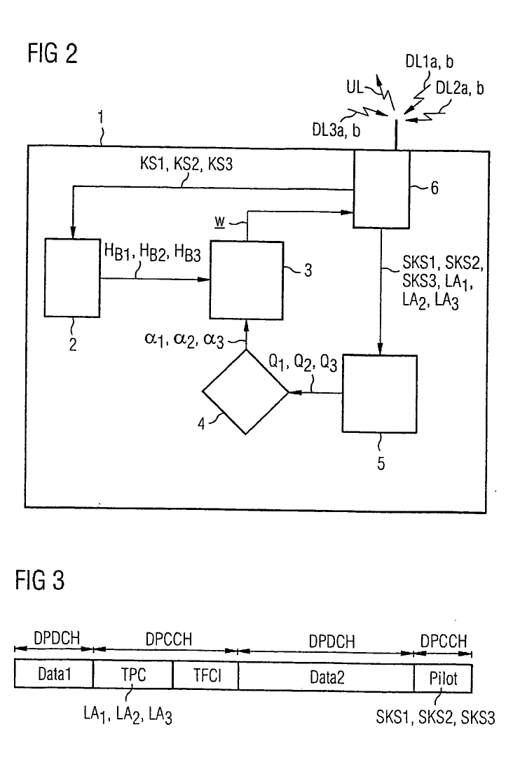

The mobile terminal 1 transmits only via an uplink channel, that is, it does not transmit specifically different signals to the different base stations BS1, BS2, BS3, but instead transmits—as is customary in the method used so far, for instance in the GSM network—signals which can be received, demodulated and/or decoded by all base stations BS1, BS2, BS3. This uplink channel is designated UL in FIG. 2. In FIG. 1 on the other hand the uplink channels to the different base stations are designated differently as UL₁, UL₂, UL₃. However, this is only intended to show that the physically identical uplink channel can be received with differing quality by the different base stations BS1, BS2, BS3.

As is also clear from FIG. 1, it is possible in the UMTS method to use a feature known as a transmit diversity method, in which the individual base stations BS1, BS2, BS3 in each case transmit in a parallel manner via two antennas A1a, A1b, A2a, A2b, A3a, A3b. By using two transmission antennas A1a, A1b, A2a, A2b, A3a, A3b on the base stations BS1, BS2, BS3 the transmission performance can be appreciably improved.

The antenna weight between the two antennas A1a, A1b, A2a, A2b, A3a, A3b should in each case be set so that the power received at terminal 1 is at maximum. For this purpose the mobile terminal 1 computes an antenna weighting factor in accordance with the method described below and transmits said factor via the uplink channel UL, UL₁, UL₂, UL₃ to the different base stations BS1, BS2, BS3.

Information on the components required in the mobile terminal 1 and how they work together is given in FIG. 2, showing in diagram form the components which are the most relevant to the present disclosure. The mobile terminal 1 also has all the other usual components such as encoder, decoder and/or modulator, demodulator, a user interface with display, keyboard, loudspeaker and microphone, an interface for a SIM card or the like together with a memory etc., with which mobile radio terminals are usually equipped. These components are all known to prior art and will therefore not be discussed further. For the same reason and in the interests of greater clarity they are not shown in FIG. 2.

To compute the antenna weighting factor, the terminal determines the channel coefficients H_{B1}, H_{B2}, H_{B3} of all currently transmitting base stations BS1, BS2, BS3. For this purpose the terminal 1 receives, by means of a normal transmitting and receiving unit 6, special control signals KS1, KS2, KS3 from the different base stations BS1, BS2, BS3. In the UMTS standard these are referred to as special training sequences—known as CPICH—for determining the channel coefficients. Each base station BS1, BS2, BS3 transmits via the two antennas, that is, via the two transmission paths DL1a, DL1b, DL2a, DL2b, DL3a, DL3b different signals on a common pilot channel CPICH.

When the control signals KS1, KS2, KS3 are being transmitted, no special antenna weighting factor is set, so that this signal is independent of the current antenna weighting factors. These control signals KS1, KS2, KS3 of the individual base stations BS1, BS2, BS3 are known to the mobile terminal 1, so that by using the signals KS1, KS2, KS3 in a channel coefficient determination unit 2, said terminal can estimate the channel coefficients H_{B1}, H_{B2}, H_{B3} for the individual transmission paths DL1a, DL1b, DL2a, DL2b, DL3a, DL3b.

The channel coefficients HB1, HB2, HB3 determined for the individual transmission paths DL1a, DL1b, DL2a, DL2b, DL3a, DL3b or base stations BS1, BS2, BS3 are then forwarded to an antenna weighting factor determination unit 3, which computes an antenna weighting factor w in accordance with the method described below. The antenna weighting factor w is then transmitted via the transmitting and receiving device 6 back along the uplink channel UL to the individual base stations BS1, BS2, BS3.

Further control signals SKS1, SKS2, SKS3, transmitted by the transmitting and receiving device 6 to a transmission channel control unit 5, are used to determine transmission quality values Q₁, Q₂, Q₃. The transmission quality values Q1, Q2, Q3 are a measure of the quality of the uplink connection UL₁, UL₂, UL₃ to the individual base stations BS1, BS2, BS3, that is, the quality with which the uplink channel UL is received by the respective base stations BS1, BS2, BS3. The control signals SKS1, SKS2, SKS3 may for instance be the pilot in the DPCCH shown at the end of a slot in FIG. 3. The signals also contain the data known to the mobile terminal, so that by comparing the received pilot signal with the known signal originally transmitted, the terminal can reach a conclusion about the antenna weighting factors that have been set. Since the terminal itself continually predefines the antenna weighting factors w, it can compare the predefined antenna weighting factor with the antenna weighting factor actually set on the respective base station BS1, BS2, BS3 in order to determine a feedback error rate which can be used as the transmission quality value Q₁, Q₂, Q₃.

Furthermore, transmission quality can be determined by using the transmission power request signals LA1, LA2, LA3 from the base stations, since said signals can be transferred to the transmission channel control unit 5. In the UMTS standard such a transmission power request signal LA1, LA2, LA3 is the TPC signal which is likewise shown within the slot in FIG. 3. The TPC commands of the individual base stations BS1, BS2, BS3 can be evaluated relatively simply.

The TPC signal consists of a bit in which TPC=1 signals to the terminal that it must increase the transmission power and TPC=0 means that the terminal must reduce the power. A continuous alternation between TPC=0 and TPC=1 means that the power is about right and that the base station concerned can receive the uplink channel well. On the other hand, in the case of a base station that continuously transmits only TPC=1 for some time, it can be assumed that the power is too low or the signal to interference ratio SIR on the uplink DPCH is too low and the feedback message cannot be reliably detected.

The transmission quality values Q₁, Q₂, Q₃ which have been determined by one or other means are then transferred to a prioritization unit 4. The unit then determines weighting factors α₁, α₂, α₃ with which the individual base stations BS1, BS2, BS3 or their channel coefficients HB1, HB2, HB3 are taken into account when the antenna weighting factor w is being computed. In the simplest case the prioritization unit 4 only checks whether the transmission quality value Q₁, Q₂, Q₃ reaches a particular threshold—for example whether the feedback error rate is under a certain error rate—and if so sets the corresponding weighting factor α₁, α₂, α₃ to 1, or if otherwise to 0.

The weighting factors α₁, α₂, α₃ are then transferred to the antenna weighting factor determination unit 3, which takes due account of said weighting factors α₁, α₂, α₃. The antenna weighting factor is then computed in a process analogous to the equation (3) mentioned above by maximizing the received power P, so that the following then applies:
P=w^{H}(α₁H_{B1}^{H}H_{B1}+α₂H_{B2}^{H}H_{B2}+α₃H_{B3}^{H}H_{B3})w (4)

As in the case of equation (3), this equation can also be expanded to any number of base stations i=1 to n.

Using the weighting factors α₁, α₂, α₃ to take account of the quality of the connection to the individual base station BS1, BS2, BS3 ensures that during computation of the antenna weighting factor, the channel coefficients HB1, HB2, HB3 have only taken into account those base stations BS1, BS2, BS3 in which there is quite a high probability that the antenna weighting factor w will be received and used correctly.

The components shown in FIG. 2 can be produced in the form of hardware modules and/or software modules in the terminal. In particular it is possible to implement some of the components, such as the transmission channel control unit, the prioritization unit, the channel coefficient determination unit and the antenna weighting factor determination unit, in the form of software on a processor that already exists in the terminal and is also used to control other functions of the terminal.

Lastly it is again noted that the configuration of the mobile radio network and terminal shown in the figures and described above is only an exemplary embodiment which can be modified by one skilled in the art without departing from the scope of the disclosure. For example it is not essential for the prioritization unit, the transmission channel control unit and the channel coefficient determination unit to consist of genuinely physical, individual units or software modules alongside the antenna weighting factor determination unit, but rather it is fully possible to combine the individual components in a function unit. In the same way it is possible for the transmission channel control unit to be combined with the prioritization unit, and/or for the channel coefficient determination unit to be integrated into the antenna weighting factor determination unit. The illustration in FIG. 2 is intended to clarify the individual stages in the process of determining the antenna weighting factor.

### KEY TO REFERENCE NUMBERS

1 Terminal
2 Channel coefficient determination unit
3 Antenna weighting factor determination unit
4 Prioritization unit
5 Transmission channel control unit
6 Transmitting and receiving unit
N Cellular radio network
w Antenna weighting factor
Q₁ Transmission quality value
Q₂ Transmission quality value
Q₃ Transmission quality value
α₁ Weighting factor
α₂ Weighting factor
α₃ Weighting factor
UL Uplink channel
H_{B1} Channel coefficient
HB₂ Channel coefficient
HB₃ Channel coefficient
UL₁ Uplink channel
UL₂ Uplink channel
UL₃ uplink channel
LA₁ Transmission power request signal
LA₂ Transmission power request signal
LA₃ Transmission power request signal
A1a Antenna
A1b Antenna
A2a Antenna
A2b Antenna
A3a Antenna
A3b Antenna
BS1 Base station
BS2 Base station
BS3 Base station
KS1 Control signal
KS2 Control signal
KS3 Control signal
DL1a Transmission path
DL1b Transmission path
DL2a Transmission path
DL2b Transmission path
DL3a Transmission path
DL3b Transmission path
SKS1 Control signal
SKS2 Control signal
SKS3 Control signal

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-10. (canceled)

11. A method for adjusting antenna weighing in a plurality of base stations communicating through a plurality of parallel transmission paths with a terminal, the method comprising the steps of:
determining channel coefficients in the terminal for each transmission path;
determining an antenna weighing factor in the terminal using said channel coefficients;
determining a transmission quality value for each transmission channel; and
prioritizing the transmission channels in the terminal, wherein each prioritization is a function of the determined antenna weighing factor and the determined transmission quality value.

12. The method according to claim 11, wherein, during the step of determining the antenna weighing factor, only the channel coefficients having a transmission quality value above a predetermined limit value are used.

13. The method according to claim 11, wherein, a weighting is applied to the channel coefficients in direct or inverse proportion to the transmission quality value of the transmission channel.

14. The method according to claim 11, wherein the transmission quality value is determined using one of a bit error rate, a frame error rate, a transmission power value, and a received power value.

15. The method according to claim 11, wherein the transmission quality value is a measure of the transmission quality of an uplink channel from the terminal and a respective base station.

16. The method according to claim 15, wherein, in order to determine the transmission quality value of the uplink channel, the terminal determines a feedback error rate by checking the respective antenna weighting factor set by the base station.

17. The method according to claim 15, wherein the terminal determines a transmission quality value for the uplink channel using transmission power request signals transmitted from the base station.

18. A mobile terminal, comprising:
an interface for communicating via a plurality of parallel transmission paths to a plurality of base stations;
a channel coefficient determination unit, communicatively coupled to the interface for determining channel coefficients for each transmission path;
an antenna weighting factor determination unit, communicatively coupled to the channel coefficient determination unit for determining an antenna weighing factor using said channel coefficients; and
a transmission channel control unit, communicatively coupled to the antenna weighting factor determination unit for determining a transmission quality value for each transmission path, wherein, during the time when the antenna weighting factor is being determined, each of the channel coefficients are prioritized used as a respective function of the determined transmission quality value.

19. The mobile terminal according to claim 18, further comprising a prioritization unit that uses the transmission quality values to determine prioritized weighting factors for each base station.
